(19) United States
(12) Patent Application Publication
(10) Pub. No.: US 2025/0251373 A1
(43) Pub. Date: Aug. 7, 2025

(54) METHOD OF MASS SPECTROMETRY

(71) Applicant: Thermo Fisher Scientific (Bremen) GmbH, Bremen (DE)

(72) Inventor: Yue Xuan, Bremen (DE)

(73) Assignee: Thermo Fisher Scientific (Bremen) GmbH, Bremen (DE)

(21) Appl. No.: 19/046,721

(22) Filed: Feb. 6, 2025

(30) Foreign Application Priority Data
Feb. 7, 2024 (GB) 2401659.4

(51) Int. Cl. G01N 30/86; B01D 15/24; G01N 30/02; G01N 30/72; H01J 49/00; H01J 49/40

(52) U.S. Cl. CPC G01N 30/8631; B01D 15/245; G01N 30/7266; H01J 49/0068; H01J 49/40; G01N 2030/027

(57) ABSTRACT

Methods of mass spectrometry comprise providing a target list of mass to charge ratios of fragments of interest for the sample to be analysed that is ionized to form sample ions. A plurality of MS2 analyses across the m/z range of interest is performed, each MS2 analysis comprising mass selecting the sample ions using an isolation window having a first m/z width and fragmenting the sample ions within the isolation window. A centre m/z of the isolation window is updated such that the plurality of MS2 analyses cover the m/z range of interest. Each MS2 analysis also comprises mass analysing the fragment ions and determining a m/z associated with each spectral peak, and comparing the m/z of the spectral peaks to the m/z of the fragments of the target list. Upon detecting a match, a triggered MS2 analysis is performed with a higher sensitivity.

### CROSS REFERENCE TO RELATED APPLICATION

This application claims priority from GB 2401659.4, filed Feb. 7, 2024, which is incorporated herein by reference.

### FIELD

The present disclosure relates to mass spectrometry. In particular, the present disclosure relates to a method of mass spectrometry including the fragmentation of ions.

### BACKGROUND

Liquid Chromatography Mass Spectrometry (LCMS) analysis of biological molecules such as proteins and the like may be performed using one of several analysis techniques.

In general, LCMS analyses may be performed in one of several domains. In an MS1 analysis, sample ions (or precursor ions) are mass analysed without intentionally fragmenting the ions. In an MS2 analysis, precursor ions (or a selection of precursor ions) are first fragmented to form fragment ions, and the fragment ion are mass analysed. MS1 and MS2 analyses may be performed separately, or performed in combination as a sample elutes from a chromatography system, in order to obtain information about the sample being analysed.

In general, there are several known approaches to ordering the MS1 and MS2 analyses in order to analyse a sample eluting from a chromatography system.

As explained in “Technical advances in proteomics: new developments in data-independent acquisition” Alex Hu, William S. Noble, Alejandro Wolf-Yadlin, F1000Research 2016, 5 (F1000 Faculty Rev): 419 (https://doi.org/10.12688/f1000research.7042.1), Data Dependent Acquisition (DDA) approaches utilise information from an MS1 analysis (i.e. an analysis of unfragmented, precursor ions present in a sample) to trigger on-the-fly MS2 analyses (analyses of fragmented precursor ions) using relatively narrow isolation windows (e.g. 1Da, 2Da, 3Da, etc). The analyses are typically triggered based on the intensities of the mass spectral peaks identified in the MS1 scan (i.e. the most intense mass spectral peaks are selected for analysis). As such, the MS2 analyses performed are “dependent” on the precursor ions identified during the MS1 analyses.

Data Independent Acquisition (DIA) approaches generally fragment all precursor ions present within a relatively wider isolation window (e.g. 10 Da, 15 Da, 20 Da etc) sequentially, wherein the resulting MS2 fragment products are analysed. The MS2 scans are repeated to cover a predefined mass to charge (m/z) range, e.g. 400-1200 m/z. As such, in a DIA approach, the MS2 analyses are performed independently of the precursor ions identified. For DIA approaches, the relatively wider m/z width of the isolation window (compared to DDA approaches) makes it more likely that multiple species of precursor ions may be included in one or more of the MS2 analyses, making the analysis of the MS2 analyses more complicated.

Targeted Mass Spectrometry approaches typically request a predefined inclusion m/z list of markers of interest. These approaches typically perform an MS1 analysis across a m/z range of interest to detect m/z of precursor ions on a predetermined inclusion list. These approaches then apply a narrow isolation window (e.g. 0.5 Da, 0.7 Da, 1 Da, 2 Da, etc) to perform a targeted MS2 analysis when the MS1 analysis scan detects a precursor ion present on the predetermined inclusion list.

GB-A-2590601 discloses a method of mass spectrometry where an isotopologue of a target precursor is added to a sample. The sample is eluted from a chromatography system and ionised. The method then comprises mass analysing the sample and isotopologue using a data independent acquisition (DIA) method of mass spectrometry including performing mass analysis scans in the MS1 domain and the MS2 domain. Upon identifying that the isotopologue is eluting form the chromatography system, the method further comprises performing target scans having a target isolation window including a mass to charge ratio representative of the target precursor over the duration of a chromatographic peak of the isotopologue for at least one of identification and quantitation of the target analyte, wherein the target scans are configured to provide additional quantitation data for the target analyte.

### SUMMARY

According to a first aspect of the disclosure, a method of mass spectrometry for analysing sample ions of a sample across a mass to charge ratio (m/z) range of interest is provided. The method comprises providing a target list of mass to charge ratios of fragments of interest for the sample to be analysed. The method comprises ionising the sample as it elutes from a chromatography system to form sample ions. The method also comprises performing a plurality of MS2 analyses of the sample ions across the m/z range of interest. Performing each MS2 analysis comprises mass selecting the sample ions using an isolation window having a first m/z width and fragmenting the sample ions within the isolation window to form fragment ions. For each of the plurality of MS2 analyses, a centre m/z of the isolation window is updated such that the plurality of MS2 analyses cover the m/z range of interest. Performing each MS2 analysis also comprises mass analysing the fragment ions and determining a m/z associated with each spectral peak of the fragment ions, and comparing the m/z of the spectral peaks to the m/z of the fragments of interest of the target list. Upon detecting a match between m/z(s) of a set of one or more spectral peak(s) and m/z(s) of a set of one or more fragment(s) of interest of the target list, the method further comprises performing a triggered MS2 analysis of the sample ions, where the triggered MS2 analysis has a higher sensitivity than a sensitivity of each of the plurality of MS2 analyses.

The method of the first aspect mass analyses a sample across a m/z range of interest in the MS2 domain. As such the method of the first aspect takes a DIA approach to the acquisition of m/z fragment data in the MS2 domain. The present inventor has realised that known DIA approaches have relatively low sensitivity due to the relatively large isolation windows used to mass select sample ions prior to fragmentation (compared to e.g. DDA approaches). While narrowing the width of the isolation window improves the sensitivity of individual MS2 analyses, this in turn increases the number of MS2 analyses required to cover the full m/z range of interest. As such, narrowing the isolation window towards the isolation window widths used for DDA (e.g. about 2 Da) increases the duty cycle for analysing the mass range of interest to such an extent that it may become challenging to perform DIA analysis on a time-scale fast enough for chromatography. For example, it may not be possible to perform a plurality of DIA cycles per chromatographic peak. This in turn reduces quantitation precision.

The inventor has further realised that a further consequence of the relatively wide isolation windows used in conventional DIA analyses is that it can be challenging to detect relatively low abundance sample ions if they are co-isolated for MS2 analyses with a higher abundance ion. That is to say, the dynamic range of the individual MS2 analyses in a conventional DIA MS2 analysis may in some circumstances be limited.

The method of the first aspect provides a method of mass spectrometry in which one or more additional triggered MS2 analyses are performed. By performing the triggered MS2 analysis with a higher sensitivity than the MS2 analyses covering the m/z range of interest, the triggered MS2 analysis may be used to target a sample ion of interest (excluding other sample ions), thereby improving the dynamic range of the triggered MS2 scan.

The triggered MS2 analysis of the first aspect is performed based on a comparison of the spectral peaks of the fragment ions with a target list of fragments of interest. As such, the triggered MS2 analysis is performed in a limited manner during the method of the first aspect. Consequently, the addition of the triggered MS2 analysis to the plurality of MS2 scans performed does not significantly increase the duty cycle of the method of mass spectrometry. Thus, the method of the first aspect allows sample ions of interest to be mass analysed using a DIA approach having improved dynamic range and without reducing quantitative precision.

The method of the first aspect performs the triggered MS2 analysis on the basis of the real-time data obtained from the plurality of MS2 analyses. The triggered MS2 analyses are part of the MS2 workflow, such that each triggered MS2 analysis is performed in real-time. As such, the triggered MS2 analysis data may be acquired in a similar time period as the MS2 analysis which prompted the triggered MS2 analysis. In particular, the triggered MS2 analyses are performed independently of any MS1 analyses, as MS1 analyses typically have a relatively long duration relative to the duration of an MS2 analysis.

In some embodiments, the triggered MS2 analysis may use an isolation window having a second m/z width, wherein the second m/z width is narrower than the first m/z width such that the triggered MS2 scan has a higher sensitivity than each of the plurality of MS2 analyses. As such the triggered MS2 analysis may provide a MS2 analysis which reduces or eliminates co-isolating a lower abundance ion with a higher abundance ion.

In some embodiments, performing each of the plurality of MS2 analyses may comprise accumulating sample ions within the isolation window for a first injection time. In some embodiments, performing the triggered MS2 analysis may comprise accumulating sample ions within the isolation window for a second injection time, wherein the second injection time is greater than the first injection time width such that the triggered MS2 scan has a higher sensitivity than each of the plurality of MS2 analyses. According to this disclosure, reference to an injection time may be understood to an accumulation of ions which is performed for a specified time period (i.e. the injection time). In some embodiments, ions may be accumulated until a predetermined amount of ions are accumulated, or a predetermined amount of charge is accumulated (i.e. a plurality of ions having one or more different charge states), or a maximum injection time is reached. In some embodiments, the isolation window having the second m/z width may be selected such that the second injection time for the triggered MS2 analysis is greater than a first injection time used for the plurality of MS2 analyses.

In some embodiments, an injection time (e.g. the first injection time and/or the second injection time) may be determined based on a predicted ion intensity for the analysis being performed. For example, in some embodiments, the method may comprise performing pre-analysis (e.g. an automatic gain control (AGC) process) using the mass analyser to estimate the intensity of sample ions across the m/z range of interest. The pre-analysis may then be used predict an ion intensity for the MS2 analysis or triggered MS2 analysis being performed.

In some embodiments, for each of the plurality of MS2 analyses, or for the triggered MS2 analysis, ions may be accumulated until a maximum injection time is reached. Such circumstances may occur when the intensity of sample ions within the isolation window of the respective MS2 analysis or triggered MS2 analysis is relatively low. In such cases, the maximum injection time used for the one or more triggered MS2 analyses may be greater than the maximum injection time used for each of the plurality of MS2 analyses. That is to say, a first maximum injection time may be provided for each of the plurality of MS2 analyses which is lower than a second maximum injection time for the one or more triggered MS2 analyses. For example, in some embodiments a first maximum injection time may be about 3.5 ms, and a second maximum injection time may be about 7 ms or 10 ms.

In some embodiments, for each of the plurality of MS2 analyses, and/or for the triggered MS2 analysis, the fragment ions may be analysed at a resolution of at least 50 000, preferably at least: 60 000, 70 000, or 80 000. For example, the ions may be analysed using a TOF mass analyser, in particular a MRTOF mass analyser. Such mass analyser may be particularly advantageous for detecting fragment ions associated endogenous analytes (e.g. endogenous peptides) in an unlabelled sample (i.e. without the presence of an internal standard).

In some embodiments, the second injection time may be estimated based on an intensity of the spectral peak(s) matching the m/z(s) of the fragment(s) of interest on the target list. For example, the intensity associated with a fragment of interest may be indicative of the concentration of the analyte of interest present in the sample, and the rate at which analyte ions of interest may be accumulated (based on a known injection time for the corresponding MS2 analysis). Accordingly, the second injection time may be selected in order to ensure a predetermined number of ions of the analyte of interest are present in the accumulated ions used for the triggered MS2 analysis.

In some embodiments, performing a triggered MS2 analysis comprises: mass selecting the sample ions with an isolation window having the second m/z width; fragmenting the sample ions within the isolation window to form triggered fragment ions; and mass analysing the triggered fragment ions wherein a mass to charge ratio associated with each spectral peak of the triggered fragment ions is identified. As such, the triggered MS2 analysis may be performed in a similar manner to the plurality of MS2 analyses. For example, the triggered MS2 analysis may be performed using the same mass analyser used to perform the plurality of MS2 analyses. In some embodiments, the triggered MS2 analysis may be performed at any point while the plurality of MS2 analyses are being performed. For example, a mass spectrometry workflow may schedule to perform the plurality of MS2 analyses sequentially (or any other order) to cover the m/z range of interest. In some embodiments, triggered MS2 analyses may be performed at any time during the workflow. For example, the triggered MS2 analyses may be appended to the end of the workflow, or may be scheduled to be performed on-the-fly. That is to say, upon determining a triggered MS2 analysis is to be performed, the workflow may be updated (or interrupted) such that the next analysis performed is the triggered MS2 analysis. By updating the workflow to schedule a triggered MS2 analysis, the triggered MS2 scan may be performed at a similar time to the MS2 analysis which prompted the triggered MS2 scan.

In some embodiments, a m/z of a spectral peak may be determined to match a m/z of a fragment of interest of the target list when the m/z of the spectral peak is within ±20 parts per million (ppm), or ±10 ppm of the m/z of the fragment of interest. As such, in some embodiments a match may be determined when the m/z of the spectral peak is within a predetermined range of a fragment of interest of the target list. In some embodiments, the accuracy criteria may be a percentage of the m/z of the fragment of interest of the target list. In other embodiments, the accuracy criteria may be a fixed range, for example ±0.1 Da. Accordingly, the method of the first aspect may be performed to a specified degree of accuracy.

In some embodiments, detecting a match between m/z(s) of a set of one or more spectral peak(s) and m/z(s) of a set of one or more fragment(s) of interest of the target list comprises identifying that an analyte (ion) of interest is present in the sample ions. As such, the target list may be provided in order to identify one or more predetermined analytes of interest in the sample.

In some embodiments, upon identifying that the analyte ion of interest is present in the sample ions, the method further comprises performing a plurality of triggered MS2 analyses, wherein each triggered MS2 analysis has an isolation window which is selected to mass select a different charge state of the analyte of interest. As such, the method of the first aspect may be used to identify and/or quantify an analyte of interest based on a plurality of MS2 measurements.

In some embodiments, upon identifying that the analyte ion of interest is present in the sample ions, the method further comprises performing a triggered MS2 analysis comprising mass selecting the sample ions with a first isolation window having the second m/z width, the first isolation window centred on a m/z of a first charge state of the analyte ion of interest, to produce first mass selected sample ions. The sample ions may also be mass selected with a second isolation window having the second m/z width, the second isolation window centred on a m/z of a second charge state of the analyte ion of interest to produce second mass selected sample ions, wherein the first and second mass selected sample ions are accumulated together. In some embodiments, the sample ions may be mass selected with the first isolation window and the second isolation window simultaneously (i.e. a multiplexed triggered MS2 scan). The accumulated first and second mass selected sample ions may be fragmented to form triggered fragment ions. The triggered fragment ions may be mass analysed wherein a mass to charge ratio associated with each spectral peak of the triggered fragment ions is identified. Thus, the triggered MS2 scan may analyse fragment ions derived from different charge states of an analyte of interest. By multiplexing the triggered MS2 analysis, the method of mass spectrometry of the first aspect may be performed in a more time-efficient manner.

In some embodiments, the sample ions to be analysed comprise a plurality of isotopically labelled versions of an analyte ion of interest. According to this disclosure, intentionally isotopically “labelled” versions of an analyte of interest and the “unlabelled” version of the analyte of interest (i.e. each atom of the analyte of interest has the expected number of neutrons) are considered to be different isotopically labelled versions of the analyte of interest. In some embodiments, the target list of m/z of fragments of interest comprise m/z of isotopically labelled fragments of interest based on the plurality of isotopically labelled versions of the analyte ion of interest. In some embodiments, one or more triggered MS2 analysis may be performed upon detecting a match between m/z(s) of a set of one or more spectral peak(s) and m/z(s) of a set of one or more fragment(s) of interest of the target list associated with one version of the plurality of isotopically labelled versions of the analyte ion of interest. As such, the triggered MS2 analysis may be triggered when one or more versions of the analyte ion of interest are detected. Thus, the triggered MS2 analysis may be performed at a time when e.g. an endogenous analyte of interest is expected to be present in the sample ions (based on the detected presence of an isotopically labelled version of analyte ion of interest). Accordingly, the triggered MS2 analysis may be performed at a suitable time. Isotopic labelling may be particularly advantageous when the analyte ion of interest has a relatively low abundance in the sample ions or is otherwise challenging to detect in the sample ions.

In some embodiments, a plurality of triggered MS2 analyses may be performed, one for each version of the plurality of isotopically labelled versions of the analyte ion of interest. As such, a triggered MS2 analysis may be performed to try to increase the number of analyte ions of interest which are analysed. In some embodiments, the method may comprise performing a multiplexed triggered MS2 analysis where first and second isolation windows are used to mass select different charge states of the analyte of interest.

It will be appreciated that the isotopic labelling may be implemented in various manners. In some embodiments, the different isotopically labelled versions of the analyte ion of interest may comprise a light isotopically labelled version of the analyte ion of interest and a heavy isotopically labelled version of the analyte ion of interest. In some embodiments, the plurality of isotopically labelled versions of the analyte ion of interest may be prepared by stable isotope labelling by amino acids in cell culture (SILAC). In some embodiments the plurality of isotopically labelled versions of the analyte ion of interest may be prepared by stable isotope dimethyl labelling. In some embodiments, the plurality of isotopically labelled versions of the analyte ion of interest may prepared by stable isotope labelling (SIL)

In some embodiments, upon identifying a match between a m/z of a spectral peak and a m/z of an isotopically labelled fragment of interest of the target list, the method may further comprise performing a triggered MS2 analysis comprising mass selecting the sample ions with a first isolation window having the second m/z width, the first isolation window centred on a m/z of one isotopically labelled version analyte ion of interest to produce first mass selected sample ions. The triggered MS2 analysis may also comprise mass selecting the sample ions with a second isolation window having the second m/z width, the second isolation window centred on a m/z of a different isotopically labelled version analyte ion of interest to produce second mass selected sample ions. In some embodiments, the first and second mass selected sample ions may be accumulated together. In some embodiments, the accumulated first and second mass selected sample ions may be fragmented to form triggered fragment ions. The triggered fragment ions may be mass analysed wherein a mass to charge ratio associated with each spectral peak of the triggered fragment ions is identified. As such, in some embodiments, the different isotopically labelled versions of the analyte ion of interest may be analysed separately for improved dynamic range and/or sensitivity. In some embodiments, different isotopically labelled versions of the analyte ion of interest may be analysed in parallel to signal to noise ratio and to improve the efficiency of the workflow.

In some embodiments, the sample to be analysed may not be isotopically labelled (i.e. internal standard molecules may not be provided in combination with sample molecules). In such embodiments, the target list may comprise a list of m/z of fragment ions of sample molecules, in particular a list of m/z of fragment ions of endogenous analytes (i.e. a spectral library of endogenous analyte fragments). As such, each MS2 analysis comprises mass analysing the fragment ions and determining a m/z associated with each spectral peak of the fragment ions, wherein the m/z of the spectral peaks are compared to the list of m/z of the fragment ions of endogenous analytes of the target list. The triggered MS2 analysis of the sample ions may then be performed based on detecting a match between m/z of a set of one or more spectral peaks and the list of m/z of fragment ions of endogenous analytes. Thus, the higher sensitivity triggered MS2 analyses of the first aspect may be advantageous to perform for experiments not utilising an internal standard in order to improve the dynamic range of the experiment, in particular in relation to relatively low intensity endogenous analytes (e.g. endogenous peptides). In some embodiments, such experiments may be performed using a Time of Flight mass analyser, preferably a multiple reflection Time of Flight (MRTOF) mass analyser. A TOF mass analyser (in particular an MRTOF mass analyser) allows the MS2 analyses and triggered MS2 analyses to be performed at a relatively high rate, for example at a frequency of at least: 150 Hz, 200 Hz, or 250 Hz. One further advantage of using a TOF mass analyser is that the analyses may be performed at a relatively high resolution and frequency. For example, each MS2 analysis may be performed at a resolution of at least 50 000, preferably at least: 60 000, 70 000, or 80 000. Each MS2 analysis may also be performed with a first m/z width of no greater than 20 Da, 15 Da, 10 Da, 8 Da, or 5 Da. The higher sensitivity of the TOF mass analyser and its faster repetition rate improves the dynamic range of the DIA method, as narrower MS2 isolation windows can be used (thereby reducing the likelihood of multiple precursor ions of significantly different abundance being isolated together in the same MS2 isolation window) while still covering the entire m/z range of interest during a DIA cycle with a duration less than a chromatographic peak. In turn, the improved dynamic range means that the triggering of triggered MS2 analyses can be performed based on detecting fragments of endogenous analytes (rather than relying on detecting ions of an isotopically labelled analyte), thereby obviating the need to spike a quantity of an isotopically labelled internal standard into the sample, and significantly reducing the complexity, time and cost of the experiment.

For example, in some embodiments a target analyte (e.g. an endogenous analyte, preferably an endogenous peptide) can be monitored by including the m/z of one or more of its in-silico predicted (or database-derived) fragment ions (optionally with an associated predicted/database-derived intensity and/or chromatographic retention time window) in the target list (i.e. without having to physically prepare an isotopically labelled version of the target). This also means that the flexibility of the experiment is increased, as many more target analytes can be included in the target list. Accordingly, the method of the first aspect may perform on-the-fly matching of m/z peaks to endogenous analytes on the target list in order to perform additional triggered MS2 analyses in real-time (i.e. whilst the detected endogenous analytes is still present). Thus, by performing triggered MS2 analyses at a relatively high resolution and frequency (using the TOF mass analyser), the dynamic range of the DIA methodology may be improved.

In some embodiments, the method of mass spectrometry may be repeated one or more times. Each cycle of the method may be performed with a duration (a cycle time) of no greater than about: 2 seconds, 1.5 seconds, 1 second, 0.7 seconds or 0.5 seconds. Accordingly, the method of mass spectrometry may be performed with a duration which is comparable to the duration of a chromatographic peak of a sample. In particular, the cycle time of the method may allow a plurality of cycles to be performed over the duration of a chromatographic peak, such that the chromatographic peak may be more accurately characterised by the method.

In some embodiments, the plurality of MS2 analyses may be performed using a Time of Flight (TOF) mass analyser at a frequency of at least 150 Hz. Accordingly, the plurality of MS2 analyses may be performed at a relatively high frequency such the number of MS2 analyses performed may be increased for a given cycle time (e.g. the MS2 analyses may be performed with a narrower isolation window).

In some embodiments, the first m/z width may be no greater than: 20 Da, 15 Da, 10 Da, 8 Da, or 5 Da. In some embodiments, the second m/z width is no greater than: 5 Da, 3 Da, or 2 Da. In some embodiments, the second m/z width may be less than the first m/z width. As such, relatively narrow width MS2 analyses may be targeted towards analyte ions of interest via the triggered MS2 scans, while the full mass range of interest is analysed using relatively wider (first width) MS2 analyses. Accordingly, the available cycle time of the method of the first aspect may provide a balance between analysing the full mass range of interest in a data independent manner, and more targeted MS2 analyses of analyte ions of interest.

In some embodiments, providing the target list of m/z fragments of interest may comprise receiving data indicative of at least one analyte of interest, using a computational model to determine a plurality of fragment ions based on the analyte of interest, and generating the target list of m/z fragments of interest based on the plurality of fragment ions. In some embodiments, the target list of m/z fragments may be obtained from one or more databases. In some embodiments, the target list of m/z fragments of interest may be obtained based on a computational model and one or more databases.

According to a second aspect of the disclosure, a controller configured to control a mass spectrometry system analyse a sample received from a chromatography system across a mass to charge (m/z) range of interest is provided. The controller is configured to:
obtain a target list of mass to charge ratios of fragments of interest for the sample to be analysed;
cause the mass spectrometry system to ionise the sample as it elutes from the chromatography system to form sample ions;
cause the mass spectrometry system to perform a plurality of MS2 analyses of the sample ions across the m/z range of interest, wherein performing each MS2 analysis comprises:
   the controller causing the mass spectrometry system to mass select the sample ions using an isolation window having a first m/z width and to fragment the sample ions within isolation window to form fragment ions, wherein for each of the plurality of MS2 analyses, a centre of the isolation window is updated such that the plurality of MS2 analyses cover the m/z range of interest;
   the controller causing the mass spectrometry system to mass analyse the fragment ions and to determine a mass to charge ratio associated with each spectral peak of the fragment ions; and
   the controller comparing the mass to charge ratios of the spectral peaks to the mass to charge ratios of the fragments of interest of the target list,
wherein upon detecting a match between m/z(s) of a set of one or more spectral peak(s) and m/z(s) of a set of one or more fragment(s) of interest of the target list, the controller is configured to cause the mass spectrometry system to perform a triggered MS2 analysis of the sample ions, where the triggered MS2 analysis has a higher sensitivity than a sensitivity of each of the plurality of MS2 analyses.

The controller of the second aspect may be configured to cause the mass spectrometry system to perform the method of the first aspect. As such, the controller of the second aspect may incorporate any of the optional features of the first aspect and any associated advantages.

According to a third aspect of the disclosure, a mass spectrometry system for analysing sample ions received from a chromatography system across a mass to charge (m/z) range of interest is provided. The mass spectrometry system comprises:
a controller according to the second aspect;
an ionisation source configured to receive sample molecules from the chromatography system and to generate sample ions;
a mass selector configured to mass select the sample ions to produce mass selected sample ions;
a fragmentation chamber configured to fragment the mass selected sample ions to produce fragment ions; and
a mass analyser configured to mass analyse the fragment ions.

The mass spectrometry system of the third aspect may be configured to perform the method of the first aspect. As such, the mass spectrometry system of the third aspect may incorporate any of the optional features of the first aspect and any associated advantages.

According to a fourth aspect, a computer program comprising instructions to cause the mass spectrometry system of the third aspect or the controller of the second aspect to execute the method according to the first aspect is provided.

According to a fifth aspect, a computer-readable medium having stored thereon the computer program of the fourth aspect is provided.

The computer program and computer-readable medium of the fourth and fifth aspects respectively may be used to cause a mass spectrometry system according to the third aspect to perform the method of the first aspect. As such, the fourth and fifth aspects may incorporate any of the optional features of the first aspect and any associated advantages.

### BRIEF DESCRIPTION OF THE DRAWINGS

Embodiments of the disclosure will now be described with reference to the following non-limiting figures in which:

FIG. 1 is a schematic diagram of a mass spectrometry system according to an embodiment of the disclosure;

FIG. 2 is a flow chart of a method of mass spectrometry according to an embodiment of the disclosure;

FIG. 3 is a diagram of a first mass spectrometry methodology which may be performed in accordance with embodiments of the disclosure;

FIG. 4 is a diagram of a second mass spectrometry methodology which may be performed in accordance with embodiments of the disclosure;

FIG. 5 is a diagram of a third mass spectrometry methodology which may be performed in accordance with embodiments of the disclosure; and

FIG. 6 is a diagram of a fourth mass spectrometry methodology which may be performed in accordance with embodiments of the disclosure.

### DETAILED DESCRIPTION

In the present disclosure, reference is made to resolutions of a mass analyser. All resolutions referenced in this disclosure will be understood by the skilled person to refer to a resolution of a mass analyser at a mass to charge ratio (m/z) equal to 200 amu (m/z=200 amu). The skilled person will understand that the m/z ratio at which the resolution of the mass analyser is specified is merely indicative of the resolution of the mass analyser at that m/z value, and is not tied to the m/z range over which the mass analyser is scanned according to the methodology of embodiments.

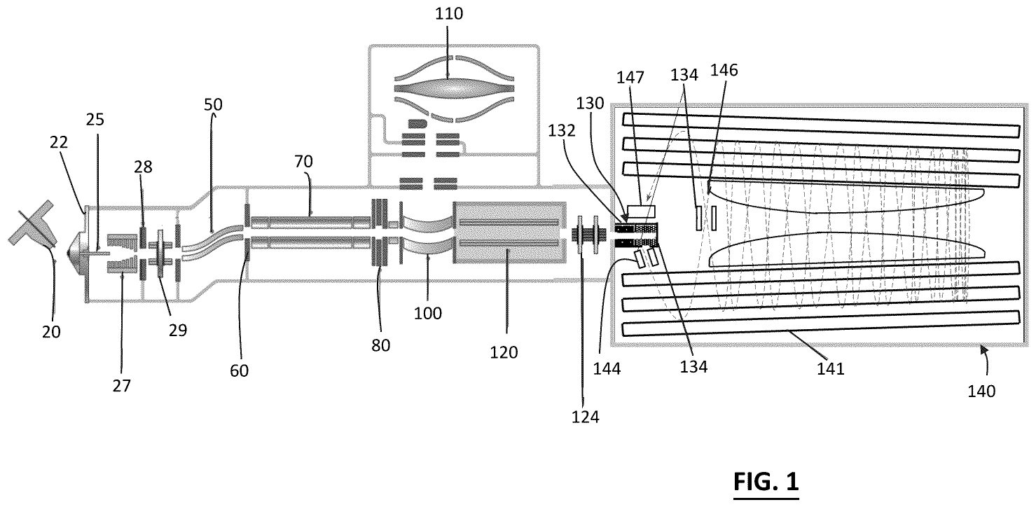

FIG. 1 shows a schematic diagram of a mass spectrometry system 10 suitable for carrying out methods in accordance with embodiments. The mass spectrometry system of FIG. 1 represents, schematically, the configuration of the Orbitrap™ Astral™ mass spectrometer from Thermo Fisher Scientific, Inc, which is a dual mass analyser mass spectrometer.

In FIG. 1, a sample to be analysed is supplied (for example from an autosampler) to a chromatography system such as a liquid chromatography (LC) column (not shown in FIG. 1). One such example of an LC column is the Thermo Fisher Scientific, Inc ProSwift™ monolithic column which offers high performance liquid chromatography (HPLC) through the forcing of the sample carried in a mobile phase under high pressure through a stationary phase of irregularly or spherically shaped particles constituting the stationary phase. In the HPLC column, sample molecules elute at different rates according to their degree of interaction with the stationary phase.

A chromatograph may be produced by measuring over time the quantity of sample molecules which elute from the HPLC column using a detector (for example a mass analyser). Sample molecules which elute from the HPLC column will be detected as a peak above a baseline measurement on the chromatograph. Where different sample molecules have different elution rates, a plurality of peaks on the chromatograph may be detected. Preferably, individual sample peaks are separated in time from other peaks in the chromatogram such that different sample molecules do not interfere with each other. On a chromatograph, a presence of a chromatographic peak corresponds to a time period over which the sample molecules are present at the detector. As such, a width of a chromatographic peak is equivalent to a time period over which the sample molecules are present at a detector. Preferably, a chromatographic peak has a Gaussian shaped profile, or can be assumed to have a Gaussian shaped profile. Accordingly, a width of the chromatographic peak can be determined based on a number of standard deviations calculated from the peak. For example, a peak width may be calculated based on 4 standard deviations of a chromatographic peak. Alternatively, a peak width may be calculated based on the width at half the maximum height of the peak. Other methods for determining the peak width known in the art may also be suitable. In some embodiments, a mass-chromatogram may be acquired using the mass spectrometry system 10. For example, in some embodiments, the mass spectrometry system 10 may repeatedly mass analyse the sample eluting from the column. In some embodiments, the mass spectrometry system 10 may mass analyse the sample in the MS1 domain to obtain the mass chromatogram.

The sample molecules thus separated via liquid chromatography may then be ionized using an electrospray ionization source (ESI source) 20 which may be at atmospheric pressure. It will be appreciated by those skilled in the art that other suitable types of ionization source may be used, such as atmospheric pressure chemical ionization (APCI), thermospray ionization etc. Sample ions then enter a vacuum chamber 22 of the mass spectrometry system 10 and are directed by a capillary 25 into an ion funnel 27. The ion funnel 27 is configured to focus the sample ions into a first quadrupole mass filter 29. A calibrant ion source 28 is also provided in the vacuum chamber 22. The calibrant ion source 28 is configured to output calibrant ions to the first quadrupole mass filter 29. As such, calibrant ions and/or sample ions may be injected into the first quadrupole mass filter 29 and subsequently analysed by the mass spectrometry system 10.

The first quadrupole mass filter 29 may be a pre-filter for the mass spectrometry system 10. Ions output from the first quadrupole mass filter 29 may be transported to a bent flatapole ion guide 50. The bent flatapole ion guide 50 may be configured to guide (charged) ions along a curved path through it. As such, the bent flatapole ion guide 50 applies low-pass ion filtering which reduces noise by removing unwanted neutral molecules, such as entrained solvent molecules, which are not guided along the curved path and are lost.

An ion gate (TK lens) 60 is located at the distal end of the bent flatapole ion guide 50 and controls the passage of the ions from the bent flatapole ion guide 50 into a downstream second quadrupole mass filter 70. The second quadrupole mass filter 70 is typically but not necessarily segmented and, when operated in a selective mode, serves as a band pass filter, allowing passage of a selected mass to charge ratio or limited mass to charge ratio range whilst excluding ions of other mass to charge ratios (m/z).The second quadrupole mass filter 70 may be operated to allow passage of ions of a relatively wide mass to charge ratio range (e.g. 40-2,500 m/z), which is useful for analysing a wide range m/z spectrum.

The second quadrupole mass filter 70 may be operated to mass select (or isolate) precursor ions using an isolation window. Typically, the second quadrupole mass filter 70 may mass select ions with an isolation window having a width of no greater than about 1,200 amu. Relatively wide isolation windows may be particularly applicable for MS1 analyses. The second quadrupole mass filter 70 may also mass select ions with an isolation window which has a width of at least 0.4 amu. Such relatively narrow isolation windows may be particularly relevant for the selection of precursor ions for analysis in the MS2 domain. The second quadrupole mass filter 70 may be configured to output ions to curved trap (C-trap) 100.

As shown in FIG. 1, ions output from the second quadrupole mass filter 70 may pass through a quadrupole exit lens/split lens arrangement and charge detector 80 on the way to C-trap 100. The C-trap 100 has longitudinally extending, curved electrodes which are supplied with RF voltages and end cap electrodes to which DC voltages are supplied to provide potential barriers at the ends of the C-trap 100. The result is a potential well that extends along the curved longitudinal axis of the C-trap 100. In a first mode of operation, the DC end cap voltages are set on the C-trap so that ions arriving from the second quadrupole mass filter 70 are captured in the potential well of the C-trap 100, where they are cooled. The injection time (IT) of the ions into the C-trap determines the number of ions (ion population) that is subsequently ejected from the C-trap. Whilst a C-trap 100 is used in the mass spectrometry system 10 of FIG. 1, in other embodiments, for example where a different type of mass analyser is used, different ion storage devices could be used instead, e.g. a linear trap with straight, not curved, electrodes. As shown in FIG. 1, the C-trap 100 is configured to eject ions orthogonally towards an orbital trapping mass analyser 110. The C-trap 100 can also eject ions axially towards fragmentation chamber 120.

In some experiments, cooled ions trapped in the C-trap 100 may be ejected orthogonally from the C-trap 100 towards orbital trapping mass analyser 110. The orbital trapping mass analyser may be an Orbitrap® mass analyser sold by Thermo Fisher Scientific, Inc. The orbital trapping mass analyser 110 has an off-centre injection aperture and the ions are injected into the orbital trapping mass analyser 110 as coherent packets, through the off-centre injection aperture. Ions are then trapped within the orbital trapping mass analyser 110 by a hyperlogarithmic electric field, and undergo back and forth motion in a longitudinal direction whilst orbiting around the inner electrode.

The axial (z) component of the movement of the ion packets in the orbital trapping mass analyser 110 is (more or less) defined as simple harmonic motion, with the angular frequency in the z direction being related to the square root of the mass to charge ratio of a given ion species. Thus, over time, ions separate in accordance with their mass to charge ratio.

Ions in the orbital trapping mass analyser 110 may be detected by use of an image current detector (not shown in FIG. 1) which produces a “transient” in the time domain containing information on all of the ion species as they pass the image current detector. The transient is then subjected to a Fast Fourier Transform (FFT) resulting in a series of peaks in the frequency domain. From these peaks, a mass spectrum, representing abundance/ion intensity versus m/z, can be produced.

In the configuration described above, the sample ions (more specifically, a subset of the sample ions within a m/z range of interest, selected by the second quadrupole mass filter 70) are analysed by the orbital trapping mass analyser 110 without fragmentation. The resulting mass spectrum is denoted MS1.

MS2 analysis (or, more generally, MSⁿ) can also be carried out by the mass spectrometry system 10 of FIG. 1. To achieve this, precursor sample ions are generated and transported to the second quadrupole mass filter 70 where a subsidiary mass range is selected. The ions that leave the second quadrupole mass filter 70 are directed (axially) through the C-trap 100 to the fragmentation chamber 120. The fragmentation chamber 120 is, in the mass spectrometry system 10 of FIG. 1, a higher energy collisional dissociation (HCD) device to which a collision gas is supplied. The potential applied to the fragmentation chamber 120 is such that precursor ions arriving into the fragmentation chamber 120 have sufficient energy that their collisions with collision gas molecules result in fragmentation of the precursor ions into fragment ions.

The fragment ions are then ejected from the fragmentation chamber 120 back towards the C-trap 100, where they are once again trapped and cooled in the potential well. Finally, the fragment ions trapped in the C-trap are ejected orthogonally towards the orbital trapping device 110 for analysis and detection. The resulting mass spectrum of the fragment ions is denoted MS2.

Although an HCD fragmentation chamber 120 is shown in FIG. 1, other fragmentation devices may be employed instead, employing such methods as collision induced dissociation (CID), electron capture dissociation (ECD), electron transfer dissociation (ETD), photodissociation, and so forth.

The fragmentation chamber 120 of FIG. 1 may be configured in a “fly through” configuration, where precursor ions enter the fragmentation chamber from one axial end of the fragmentation chamber 120 and fragmented ions exit the fragmentation chamber 120 from an opposing axial end. Fragmented ions may also be ejected from the fragmentation chamber 120 back to the C-trap 100 for analysis in the orbital trapping mass analyser 110. Fragmented ions may be ejected from the fragmentation chamber 120 for analysis in the MS2 domain. Alternatively, precursor ions may be transported axially through the fragmentation chamber 120 without fragmentation, as discussed below.

As shown in FIG. 1, ions (fragmented ions or unfragmented precursor ions) may be ejected from the fragmentation chamber 120 to an ion guide 124. Ion guide 124 shown in FIG. 1 is an RF multipole ion guide. The ion guide 124 is configured to transport ions from the fragmentation chamber 120 to an extraction trap 130. The extraction trap 130 is configured to accumulate ions received from the fragmentation chamber 120 for injection into a Time of Flight (TOF) mass analyser. In the embodiment of FIG. 1, the TOF mass analyser is a Multiple Reflection Time of Flight (MRTOF) mass analyser 140, although other types of mass analyser may also be used. Further information regarding the general instrument layout shown in FIG. 1 has been previously described in U.S. Pat. Nos. 10,699,888 and 10,593,525, for example.

In some embodiments, fragmented ions may be transferred from the fragmentation chamber 120 to the extraction trap 130 (via ion guide 124) for injection into the MRTOF mass analyser 140. Ions (e.g. fragmented ions) are accumulated by the extraction trap 130 for injection into the MRTOF 140. Accumulated ions may be injected into the MRTOF 140 as a coherent packet. In some embodiments, extraction trap 130 may comprise a high-pressure region 132 followed by a low pressure region 134. First trapping electrodes may be provided with a first RF voltage in the low pressure region 134 and second trapping electrodes with a second RF voltage may be provided in the high pressure region 132. In the low pressure region 134, vacuum pumping may be provided at a rate of about 20 L/s. In the high pressure region 132, N2 buffer gas may be provided through a capillary (not shown in FIG. 1). A diaphragm may be provided between the low pressure region 134 and the high pressure region 132. Such an extraction trap is further described in GB-A-2613439.

As such, ions may be transferred from the ion guide 124 in the axial direction to the high pressure region 132 of the extraction trap 130. Ions trapped in the high pressure region 132 may then be transferred to the low pressure region 134 of the extraction trap. Ions may then be cooled in the low pressure region 134 and ejected into the MRTOF 140. To increase the frequency of MS2 analyses performed using MRTOF 140, ion packets may be processed in parallel using the quadrupole mass filter 70, fragmentation chamber 120, ion guide 124, extraction trap 130 and MRTOF 140. In particular, an ion packet may be transferred from the fragmentation chamber 120 to the high pressure region 132 of the extraction trap 130 in parallel with the ejection of ions from the low pressure region 134 of the extraction trap 130 into the MRTOF 140. The parallelisation of stages by pre-trapping ions in the high pressure region 132 of the extraction trap 130, whilst the low pressure region completes its sequence (ion cooling, high voltage lift, extraction to MRTOF 140) is further described in US-A-20190103263.

As noted above, in some embodiments (unfragmented) precursor ions may be transferred from the quadrupole mass filter 70 through the fragmentation chamber 120 to the extraction trap 130 without undergoing fragmentation. Where MS2 analysis is desired, in some embodiments the precursor ions may be fragmented in high pressure region 132 of the extraction trap 130. Fragmentation of precursor ions in the high pressure region 132 may be controlled through control of the pressure of the high pressure region 132 and application of suitable DC voltages to induce fragmentation for example.

The MRTOF 140 comprises a first converging ion mirror 141 and a second converging ion mirror 142. The first and second converging ion mirrors 141, 142 are arranged opposite each other in order to define an ion trajectory which involves multiple reflections between the first and second converging ion mirrors 141, 142. As further shown in FIG. 1, ions are input into the MRTOF 140 from the extraction trap 130. The ions travel from the extraction trap 130 through an ion optics assembly 144, before travelling between the converging ion mirrors 141, 142. The ion optics assembly 144 may comprise one or more focusing lenses and/or ion deflectors is configured to focus the ion packet ejected from the extraction trap 130 into the MRTOF 140. As shown in FIG. 1, ions ejected from the extraction trap 130 travel along an axial direction of the MRTOF 140 as they are reflected between the first and second converging ion mirrors 141, 142. The converging ion mirrors 141, 142 cause the ions to reverse their axial direction of travel such that the ions subsequently travel back along the converging ion mirrors 141, 142 where they are captured by an ion detector 147. In the MRTOF 140 of FIG. 1, a pair of correcting stripe electrodes 146 are provided between the converging ion mirrors 141, 142. Further details of the MR-TOF 10a may be found in at least U.S. Pat. No. 9,136,101.

The mass spectrometry system 10 is under the control of a controller (not shown) which, for example, is configured to control the timing of ejection of the trapping components, to set the appropriate potentials on the electrodes of the quadrupole mass filters etc. so as to focus and filter the ions, to capture the mass spectral data from the orbital trapping mass analyser 110 and MRTOF 140, control the sequence of MS1 and MS2 scans and so forth. It will be appreciated that the controller may comprises a computer that may be operated according to a computer program comprising instructions to cause the mass spectrometer to execute the steps of the method according to embodiments.

It is to be understood that the specific arrangement of components shown in FIG. 1 is not essential to the methods subsequently described. Indeed, other arrangements for carrying out the methods of embodiments are suitable. For example, an additional Time of Flight mass analyser or a Fourier transform Ion Cyclotron Resonance (FT-ICR) mass analyser can be used instead of an orbital trapping mass analyser 110.

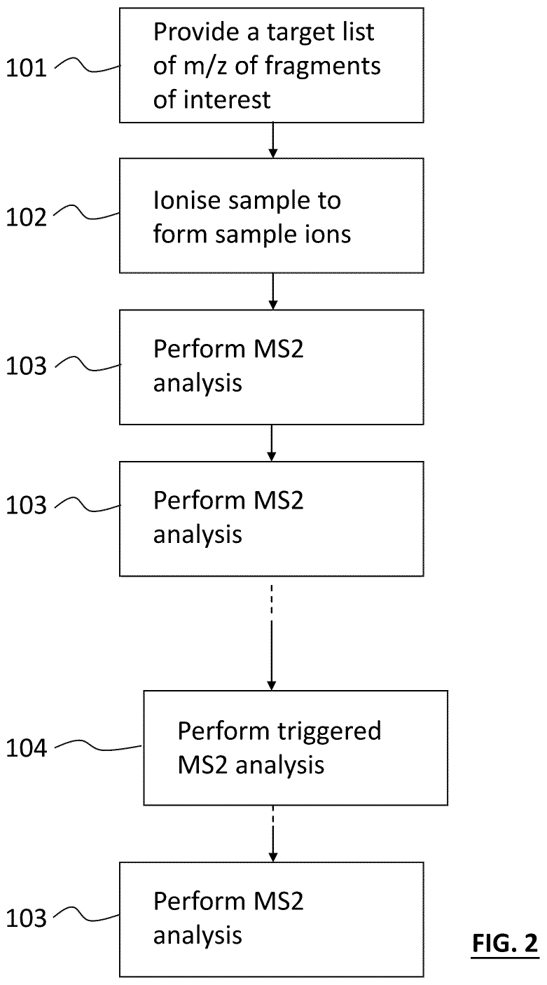

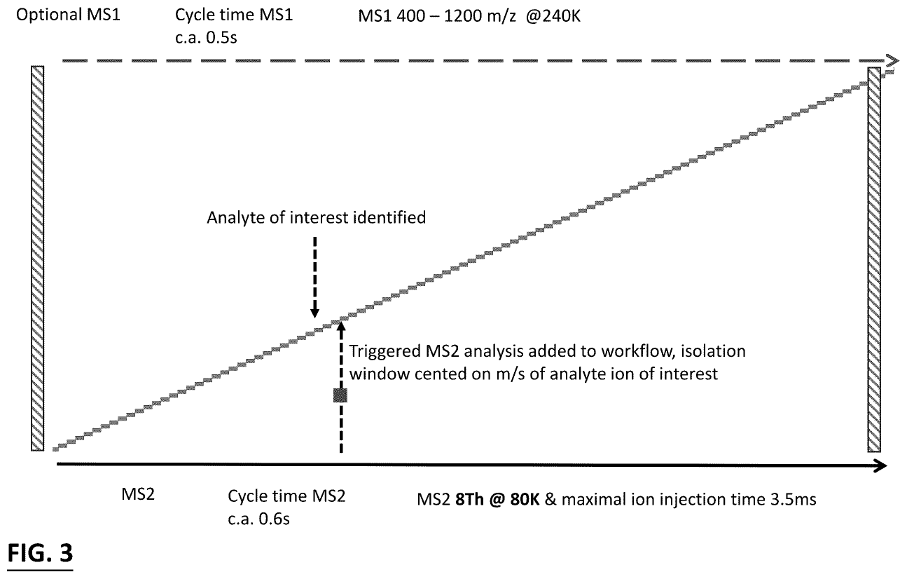

An embodiment of the method will now be described with reference to FIGS. 2 and 3.

The sample to be analysed contains sample molecules. In some embodiments, the composition of the sample may be entirely unknown. In some embodiments, the sample may include, or be expected to include, at least one analyte of interest. The sample may be supplied from a liquid chromatography (LC) column connected to the mass spectrometry system 10 described above (as shown in FIG. 1).

In some embodiments, the sample to be analysed may comprise one or more isotopically labelled versions of an analyte molecule of interest, although isotopic labelling is not necessary. That is to say, an isotopically labelled version of an analyte molecule (i.e. an isotopologue) may be intentionally added to the sample. An isotopically labelled version of analyte molecule is a molecule which has the same chemical structure as the parent molecule (i.e. the analyte molecule of interest) and differs from its parent molecule in that at least one atom of the isotopically labelled version has a different number of neutrons. In some embodiments, the analyte of interest may only be present in a sample, if present at all, in relatively low abundance (e.g. endogenous peptides), thereby making it challenging to detect using conventional DIA methodologies. Isotopic labelling may assist with the detection of such relatively low abundance compounds.

In particular, for a given sample, the retention time of an analyte of interest may not be known prior to performing a DIA methodology. As the analyte of interest may only be present in the sample in low quantities, it may be challenging to determine the retention time using conventional methods. Accordingly, an isotopically labelled version of the analyte of interest may be added to the sample in a quantity that is sufficient to enable reliable detection of the added isotopically labelled version by mass analysis. As such, the sample can be considered to comprise a plurality of isotopically labelled versions of the analyte of interest (i.e. the added isotopically labelled version and the unlabelled analyte of interest are considered to be different isotopically labelled versions of the analyte of interest). As the added isotopically labelled version of the analyte of interest has the same chemical structure as the unlabelled analyte of interest, the retention time of the added isotopically labelled analyte of interest will be similar to or the same as the analyte of interest.

In some embodiments, different isotopic labels of may be applied to an analyte of interest. Each isotopically labelled version of the analyte of interest may have a different isotopic label, but be chemically the same. The different isotopically labelled analyte of interests may be added to the sample in different known amounts. For example, in some embodiments, a sample may comprise a “light” isotopically labelled version of the analyte of interest may (i.e. the endogenous version of the analyte of interest). In some embodiments, a “heavy” isotopically labelled version analyte of interest may be added to the sample. The “heavy” isotopically labelled version of the analyte of interest typically comprises a greater amount of atoms including additional neutrons (e.g. ¹³C, ¹⁵N, deuterium, etc.) relative to the light isotopically labelled analyte of interest.

In some embodiments, the plurality of isotopically labelled versions of the analyte of interest may be prepared by stable isotope labelling by amino acids in cell culture (SILAC). In a SILAC process, an isotopic label by incorporated in vivo into one or more proteins. In some embodiments, a SILAC process may incorporate a relatively “light” or relatively “heavy” form of an amino acid (e.g., labelled with deuterium, ¹³C, or ¹⁵N) into all newly synthesized proteins. As the “light” and “heavy” forms of the amino acids used are virtually identical, “heavy” cells behave similar to cells grown in “light” media. In other embodiments, the isotopically labelled version(s) of the analyte of interest may be prepared by stable isotope dimethyl labelling. By using combinations of several isotopomers of e.g. formaldehyde, cyanoborohydride, a plurality of different isotopic labels (e.g. at least 2different isotopic labels, or at least 3 different isotopic labels) may be prepared for a single analyte of interest. Each isotopic label may differ in mass by at least 2 Da, preferably at least 4 Da, from adjacent isotopic labels to allow for simplified analysis.

In the embodiment of FIGS. 2 and 3, the sample molecules may be supplied from the LC column such that methodology according to embodiments acquires data about the sample molecules and any isotopically labelled versions of the analyte of interest molecules (when included) as they elute from the chromatography system. It will be appreciated that over the course of an experiment the LC column may at times, only supply sample molecules, only isotopically labelled molecules, or supply sample molecules and isotopically labelled molecules to the mass spectrometer depending on the retention times of the sample molecules and the isotopically labelled molecules. Reference to the supply of sample molecules and/or isotopically labelled molecules from the LC column in this disclosure will be taken to include any of the above cases.

According to methods of this disclosure, the mass spectrometry system 10 analyses the sample molecules and the isotopically labelled analyte of interest molecules (when present) according to a methodology comprising a plurality of MS2 analyses. In some embodiments, one or more MS1 analyses may also be performed. FIG. 2 is a flow chart showing a method 100 of mass spectrometry for analysing a sample across a mass to charge ratio (m/z) range of interest according to an embodiment of the disclosure. The method 100 indicates the steps which may be performed in a single cycle. In some embodiments, a plurality of cycles may be performed as a sample elutes from a chromatography system.

The m/z range of interest may be predetermined prior to commencing the method. For example, the m/z range of interest may be selected by a user. Alternatively, the mass spectrometry system 10 may be configured to analyse ions across a predetermined m/z range of interest. For example, the mass spectrometry system 10 of FIG. 1 may be configured to analyse ions having a m/z in a range of 400 to 1100 m/z.

In step 101, the method 100 comprises providing a target list of m/z of fragments of interest for the sample to be analysed. As such, the target list provides a list of one or more m/z, each m/z being indicative of a m/z of a known ion fragment. The method 100 may take further action (performing a triggered MS2) scan upon detecting a spectral peak having a m/z which corresponds to a m/z on the target list. The target list may be populated with m/z of fragments on interest in accordance with various methodologies.

In some embodiments, the target list of m/z of fragments of interest may be a predetermined list of m/z of fragments of interest provided by the mass spectrometry system 10. For example, in some embodiments, the target list may comprise m/z of one or more known fragments of an analyte (molecule) of interest. As such, in some embodiments, the mass spectrometry system 10 may receive data indicative of at least one analyte of interest, for example a user selection. In some embodiments, the user may also input m/z for one or more known fragments of the analyte of interest. In some embodiments, the mass spectrometry system 10 may utilise a computational model to determine a one or more fragment ions based on the analyte of interest. The mass spectrometry system 10 may then populate the target list of m/z fragments of interest based on the determined fragment ion(s). Various in silico computational models for determining fragment ions from a precursor ion (i.e. an analyte ion of interest) are known to the skilled person.

In some embodiments where the sample ions to be analysed comprise a plurality of isotopically labelled versions of an analyte ion of interest, the target list may be updated based on the isotopic labelling. As such, the target list of m/z of fragments of interest may comprise m/z of isotopically labelled fragments of interest based on the plurality of isotopically labelled versions of the analyte ion of interest. For example, where the sample comprises a “light” isotopically labelled version of an analyte of interest and a “heavy” isotopically labelled version of the analyte of interest, the target list may be populated with a m/z of a “light” fragment of interest and a m/z of a “heavy” version of the same fragment of interest. In some embodiments where a computational model is used to determine one or more fragment ions, the user may also input information regarding the isotopic labelling of the sample. Accordingly, the mass spectrometry system 10 may then populate the target list of m/z fragments of interest based on the determined fragment ion(s) and one or more isotopically labelled versions of the determined fragment ions.

In step 102, the method 100 comprises ionising the sample as it elutes from a chromatography system to form sample ions. In the system of FIG. 1, sample ions may be ionised by the electrospray ionization source 20. As noted above, the method 100 may be performed a plurality of times as the sample elutes from the chromatography system. Thus, at different points during the experiment, different sample molecules may be eluting from the chromatography system. In particular, the retention time of one or more analytes of interest may not be known prior to the experiment.

In step 103, the method comprises performing a plurality of MS2 analyses of the sample ions across the m/z range of interest (e.g. m/z 400 to 1200). Performing each MS2 analysis comprises mass selecting the sample ions using an isolation window.

According to this disclosure, each isolation window has a width (i.e. a first width) and is centred at a specific m/z. As such, each isolation window spans from a first m/z value to a second m/z value, wherein the difference between the first and second m/z values is defined by the (first) width of the isolation window. The first and second m/z values may be spaced apart equally from a centre m/z value of the isolation window. The first and second m/z values/the centre m/z of the isolation window may be updated for each of the plurality of MS2 analyses, such that the plurality of MS2 analyses cover the m/z range of interest. For example, a centre m/z value may be incremented by the first width for each successive MS2 analysis such that the plurality of MS2 analyses include all sample ions within the mass range of interest. While the plurality of MS2 scans may, in some embodiments be performed in an ascending order of a central m/z value, in other embodiments the plurality of MS2 scans may be performed in a descending order (of central m/z value) or in a random order.

In the system of FIG. 1, sample ions may be transferred to the second quadrupole mass filter 70 for mass selection. The second quadrupole mass filter 70 may then filter out any sample ions having a m/z falling outside the isolation window. As noted above, a centre m/z value for the isolation window may be updated for successive MS2 analyses.

For performing a MS2 analysis, the first width of the isolation window may be relatively narrow (compared to an MS1 analysis). The first width of the isolation window may be the same for each of the plurality of MS2 analyses. For example, in some embodiments the width of the isolation window may be no greater than: 20 Da, 15 Da, 10 Da, 8 Da, or 5 Da. As the first width of the isolation window is decreased, the MS2 analysis may be more selective. That is to say the number of different species of sample ions included within an isolation window may decrease as the width of the isolation window is reduced. Decreasing the first width of the isolation window increases the number of MS2 analyses required to cover a given mass range of interest, which in turn increases the cycle time of the method 100. As such, in some embodiments, the width of the isolation window may be at least: 2 Da, 3 Da, 4 Da, or 5 Da.

When performing each of the plurality of MS2 analyses, sample ions may be accumulated within the isolation window for a time period, a first injection time. In the embodiment of FIG. 1, mass selected ions from the quadrupole mass filter 70 ions may be accumulated in the fragmentation chamber 120 (without undergoing fragmentation), although the ions may be accumulated in any other suitable ion trap of the mass spectrometry system 10. In some embodiments, ions may be accumulated for a predetermined amount of time (the first injection time). In some embodiments, ions may be accumulated until a predetermined quantity of ions is accumulated, until a predetermined amount of charge is accumulated, or until a first maximum injection time is reached.

In some embodiments, the accumulated sample ions may be fragmented in fragmentation chamber 120. In the embodiment of FIG. 1, a packet of ions is accumulated in fragmentation chamber 120 in parallel with further processing of ion packets downstream in the extraction 130. An accumulated ion packet may be transferred from fragmentation chamber 120 to the high pressure region 132 of extraction trap 130. Sample ions may then undergo fragmentation in the high pressure region 132 before being transferred to the low pressure region 134. The fragmented ions are injected from the low pressure region 134 of the extraction trap 130 into the MRTOF 140 as a coherent ion packet. The MRTOF 140 measures the time of flight for each ion within the injected ion packet and determines a m/z associated with each spectral peak of the fragment ions. As such, the MRTOF 140 may generate a set of one or more spectral peaks having associated m/z(s) for the MS2 analysis performed.

For each MS2 analysis performed, the controller of the mass spectrometry system 10 compares the m/z(s) of the set of spectral peaks from the MS2 analysis to the m/z(s) of the fragments of interest of the target list. Where a match is detected, the method 100 proceeds to perform one or more triggered MS2 analysis (step 104). In some embodiments, a m/z of a spectral peak is determined to match a m/z of a fragment of interest of the target list when the m/z of the spectral peak is within, for example about: ±20 ppm, or ±10 ppm of the m/z of the fragment of interest. While in some embodiments, the match range may be based on a percentage of the m/z, in other embodiments, the match range may be an absolute range, for example, about ±0.1 Da, ±0.05 Da, ±0.03 Da, ±0.02 or ±0.01 Da.

In step 104, the method comprises performing one or more triggered MS2 analyses of the sample. A triggered MS2 analysis may be performed upon detecting a match between m/z(s) of a set of one or more spectral peak(s) and m/z(s) of a set of one or more fragment(s) of interest of the target list. In some embodiments, detecting a single match between a m/z of one spectral peak and one m/z of a fragment of interest may be sufficient to trigger the triggered MS2 analysis. In other embodiments, the method 100 may require at least two matches between two spectral peaks and corresponding fragments of interest of the target list. As such, to reduce or eliminate false positive triggered MS2 analyses, a triggered MS2 analysis may only be performed where the set of spectral peaks match with at least two fragments associated with an analyte of interest are present in the fragmented ions.

According to step 104, a triggered MS2 analysis is an MS2 analysis which has a higher sensitivity than a sensitivity of each of the plurality of MS2 analyses (i.e. the MS2 analyses performed in step 103). The triggered MS2 analysis of the sample may be performed based on the one or more matches between the m/z(s) of the set of spectral peak(s) and the m/z(s) of the target list. As such, the one or more matches may be indicative of an analyte of interest, wherein the triggered MS2 analysis performed may be a relatively high sensitivity MS2 analysis of the analyte of interest. For example, the triggered MS2 analysis may utilise an isolation window which is centred on a m/z associated with the indicated analyte of interest.

According to the embodiment of FIG. 2, performing a triggered MS2 analysis comprises mass selecting the sample ions with an isolation window having a second m/z width. The sample ions may be mass selected using the second quadrupole mass filter 70. The mass filtered sample ions may then be transferred to the fragmentation chamber 120 where the sample ions are fragmented to form triggered fragment ions. The triggered fragmented ions may then be mass analysed using the MRTOF 140 wherein a m/z associated with each spectral peak of the triggered fragment ions is identified.

In some embodiments, the second width of the isolation window used to mass select the sample ions for the triggered MS2 analysis may be narrower than the first width of the isolation window used for the plurality of MS2 analyses (step 103). As the second width is narrower than the first width, the triggered MS2 analysis may have a higher sensitivity than each of the plurality of MS2 analyses. For example, the second width may be no greater than 3 Da, 2 Da, 1 Da, or 0.5 Da. In some embodiments, the second width may be no greater than: 70%, 60%, or 50% of the first width.

When performing the triggered MS2 analysis, the sample ions may be accumulated within the isolation window for a second injection time. In some embodiments, the sensitivity of the triggered MS2 analysis may be increased by increasing the duration of the second injection time such that it is greater than the first injection time. For example, by narrowing the second width of the second isolation window, the intensity of sample ions may be lower such that the fill rate of ions for the triggered MS2 analysis is slower than for the plurality of MS2 analyses. In some embodiments, where the intensity of sample ions within the isolation window is relatively low, ions may be accumulated up to a second maximum injection time. In some embodiments, the second maximum injection time may be greater than the first maximum injection time. For example, in some embodiments where the first maximum injection time is about 3.5 ms, the second maximum injection time may be about 5 ms. Thus, by adjusting the second maximum injection time, the triggered MS2 analysis may provide a triggered MS2 analysis having a longer injection time than each of the plurality of MS2 analyses.

In some embodiments, the method 100 may comprise performing a pre-analysis (e.g. an automatic gain control (AGC) process) using a mass analyser (either the orbital trapping mass analyser 110 or the MRTOF mass analyser 140) to estimate the intensity of sample ions across the m/z range of interest. The pre-analysis may then be used predict an ion intensity for the MS2 analysis or triggered MS2 analysis being performed.

FIG. 3 shows a first schematic workflow for a method of mass spectrometry according to this disclosure. The workflow of FIG. 3 may be performed by the system of FIG. 1. As shown in FIG. 3, a plurality of MS2 analyses are performed across the mass range of interest (400 to 1200 m/z). Each MS2 analysis is performed with an isolation window of 8 Da such that 100 MS2 analyses are performed to cover the m/z range of interest. Each MS2 analysis uses a maximum injection time of 3.5 ms, and about 1.5 ms of overhead time means that each MS2 analysis takes, on average, about 5 ms to complete. As such, the plurality of MS2 analysis may be performed by the MRTOF 140 at a frequency of about 200 Hz. Thus, the plurality of MS2 analyses can be performed across the entire mass range of interest in about 0.5 s.

As shown in FIG. 3, an MS1 analysis is also performed in parallel with the plurality of MS2 analyses. The MS1 analysis uses the orbital trapping mass analyser 110 to mass analyse the sample ions in the MS1 domain across the mass range of interest (400 to 1200 m/z). As indicated in FIG. 3, an MS1 analysis can be performed at a resolution of about 240,000 in about 0.5 s. As such, it will be appreciated that the duration of the MS1 analysis is comparable to the duration of the plurality of MS2 analyses.

As shown in FIG. 3, the method also comprises performing one or more triggered MS2 analyses. The triggered MS2 analysis is triggered when the spectral peak(s) from an MS2 analysis match the m/z(s) of a set of one or more fragment(s) of interest of the target list. The set of one or more fragment(s) of interest of the target list may correspond to one or more analytes of interest. For example, in some embodiments, the target list may comprise a list of m/z of fragments of endogenous analytes.

In embodiments where the target list comprises a list of m/z of fragments of endogenous analytes, and an internal standard is not provided with the sample, it may be preferable to perform the MS2 analyses and the triggered MS2 analyses using a TOF mass analyser (e.g. MRTOF 140). The higher sensitivity of the TOF mass analyser (e.g. compared to an ion trap mass analyser for example) and its faster repetition rate improves the dynamic range of the DIA method, because narrower MS2 isolation windows can be used (thereby reducing the likelihood of multiple precursor ions of significantly different abundance being isolated together in the same MS2 isolation window) while still covering the entire m/z range of interest during a DIA cycle with a duration less than a chromatographic peak. For example, in some embodiments the first width of the isolation window used to perform the plurality of MS2 analyses may be no greater than 10 Da, 8 Da, 5 Da, or 3 Da. The TOF mass analyser 140 may also be operated with a relatively high resolution, for example a resolution of at least 50 000, preferably at least: 60 000, 70 000, or 80 000.

Where only one analyte of interest is identified by the target list, the triggered MS2 analysis may be a single ion monitoring (SIM) analysis of the analyte of interest. For example, the triggered MS2 analysis may be performed with an isolation window having a second width of no greater than 2 Da. The isolation window may be centred on the m/z of the analyte ion of interest. To further increase the sensitivity of the SIM analysis, the second injection time used for the triggered MS2 analysis may be increased, for example the second injection time may be at least 8.5 ms. As such, each triggered MS2 analysis may increase the duty cycle of the method by about 10 ms.

Where two or more analytes of interest are identified in the same MS2 analysis by the target list, separate triggered MS2 scans may be performed for each analyte of interest (i.e. separate SIM analyses for each analyte of interest). As such, the isolation windows for each triggered MS2 scan may be centred to mass select only one analyte of interest. As such, by performing separate SIM scans, the dynamic range used to analyse each analyte of interest in the MS2 domain may be improved by isolating the analytes of interest separately from each other.

Thus, the method of mass spectrometry shown in FIG. 3, may perform one or more triggered MS2 analyses, depending on the number of analytes of interest which are present in the sample at the time of the method. For example, where three analytes of interest are co-eluting from the chromatography system, three triggered MS2 scans may be performed over the duty cycle. As such, the three triggered MS2 scans cause the duty cycle to be increased from 0.5 s (for the 100 MS2 analyses) to 0.530 s (500 ms+3×10 ms). Thus, it will be appreciated that including a limited number of triggered MS2 analyses in the methodology does not result in a significant longer duty cycle. As such, the duty cycle duration remains generally aligned with the duration of the MS1 analysis, such that the MS2-based methodology can be efficiently performed in parallel with an MS1 analysis.

While the embodiment of FIG. 3 indicated one possible implementation of a triggered MS2 analysis, the triggered MS2 analysis may be performed in different manners depending on the nature of the experiment being conducted and the desired data to be obtained.

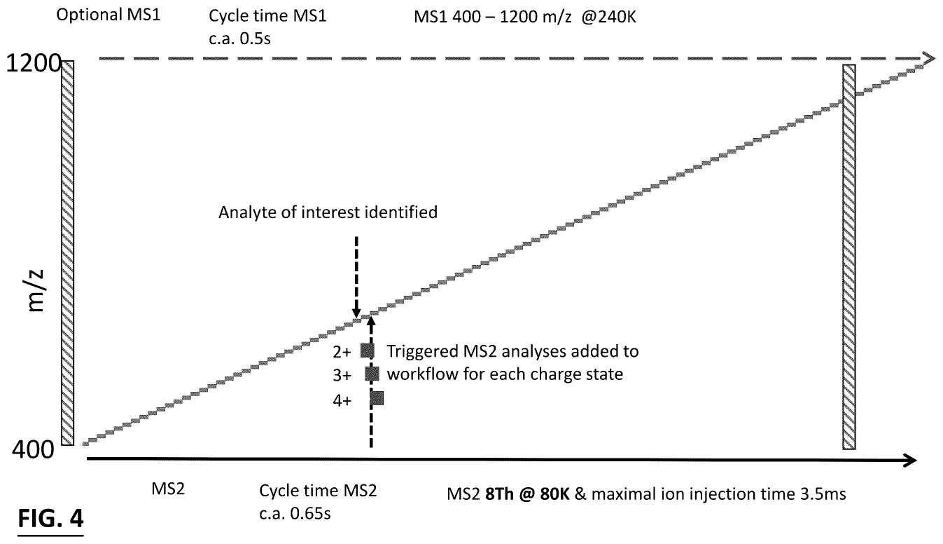

FIG. 4 shows a second schematic workflow for a method of mass spectrometry according to this disclosure. In FIG. 4, one or more triggered MS2 analyses may be performed for a single analyte of interest having different charge states. That is, upon identifying that the analyte ion of interest is present in the sample ions, one or more triggered MS2 analyses may be performed having isolation windows which mass select a different charge state of the analyte of interest (e.g. the +2, +3 and +4 charge states of an analyte ion of interest). By analysing different charge states of an analyte of interest using triggered MS2 analyses, the method may increase the amount of analyte ions of interest which are analysed by the method. In particular, for relatively low abundance analyte ions of interest, analysing a plurality of charge states may improve the signal to noise ratio of the analysis. For example, in embodiments where the target list comprises a list of m/z of fragments of endogenous analytes, and an internal standard is not provided with the sample, it may be advantageous to analyse a plurality of charge states of the endogenous analyte of interest, in order to improve the signal to noise ratio.

In some embodiments, the different charge states may each be analysed in separate triggered MS2 analyses (e.g. in separate SIM MS2 analyses), similar to the SIM analyses described above in relation to FIG. 3.

In some embodiments, the different charge states may be analysed together in a single triggered MS2 analysis (i.e. a parallel reaction monitoring (PRM) analysis). That is, the sample ions may be mass selected with different isolation windows (each isolation window corresponding to a different charge state) simultaneously. As such, in the method of FIG. 4, upon identifying that the analyte ion of interest is present in the sample ions, a triggered MS2 analysis is performed comprising mass selecting the sample ions with a first isolation window (i.e. a first mass selecting step) having the second m/z width. The first isolation window may be centred on a m/z of a first charge state of the analyte ion of interest to produce first mass selected sample ions. The mass selecting step may be performed by the second quadrupole mass filter 70. The first mass selected sample ions may be accumulated in the second quadrupole mass filter 70, and/or transferred to C-trap 100 as an intermediate step following mass selection. Similar to the triggered MS2 analyses described above, the second m/z width may be relatively narrow, e.g. no greater than: 5 Da, 3 Da, or 2 Da.

The triggered MS2 analysis also comprises mass selecting the sample ions (i.e. a second mass selecting step) with a second isolation window having the second m/z width, the second isolation window centred on a m/z of a second charge state of the analyte ion of interest to produce second mass selected sample ions. The second mass selecting step may be performed sequentially with the first mass selecting step, wherein the first and second mass selected sample ions are accumulated together in the C-trap 100. Alternatively, in some embodiments, the second quadrupole mass filter 70 may apply a comb-like mass filter which applies the first and second isolation windows in parallel. As such, the mass filter may mass select sample ions having m/z falling within either the first isolation window or the second isolation window at the same time such that the first and second mass selected sample ions are accumulated in the second quadrupole mass filter 70. Other methods for mass selecting the first and second mass selected sample ions may also be suitable for accumulating sample ions corresponding to different charge states of the analyte ion of interest.

While the above description refers to the mass selection of two different charge states for an analyte ion of interest, it will be appreciated that the same principles may be applied to the mass selection of e.g. at least three different charge states of an analyte ion of interest (e.g. as shown in FIG. 4).

Once accumulated, the first and second mass selected sample ions may be transferred to the fragmentation chamber 120. Inside the fragmentation chamber 120, the accumulated first and second mass selected sample ions are fragmented to form triggered fragment ions. The fragmentation process may be performed as described above in relation to other embodiments of the disclosure. The resulting triggered fragment ions may then be transferred to the MRTOF 140. The triggered MS2 analysis may then comprise mass analysing the triggered fragment ions wherein a m/z associated with each spectral peak of the triggered fragment ions is identified.

In the embodiment of FIG. 4, the m/z range of interest (400 to 1200 m/z) is analysed in the MS2 domain with a 100 MS2 analyses, each MS2 analysis having a first m/z width of 8 Da and a first injection time of 3.5 ms (total MS2 analysis duration 5 ms). The sample ions may also be analysed in parallel in the MS1 domain using the orbital trapping mass analyser 110 (similar to FIG. 3). As shown in FIG. 4, three triggered MS2 analyses are performed. A first triggered MS2 analysis is performed for an analyte of interest having a 2+ charge state, a second triggered MS2 analysis is performed for an analyte of interest having a 3+ charge state, and a third triggered MS2 analysis is performed for an analyte of interest having a 4+ charge state. In the embodiment of FIG. 4, analyte ions of each charge state are mass selected separately, with each charge state having a second injection time of about 5 ms. The three sets of mass selected sample ions may be co-fragmented and co-analysed in the MS2 domain (i.e. PRM process) or analysed separately (i.e. a SIM process). Performing the additional triggered MS2 analyses increases the duty cycle by about 15 ms, corresponding to the additional injection times introduced to accumulate the different charge states of the analyte ion of interest.

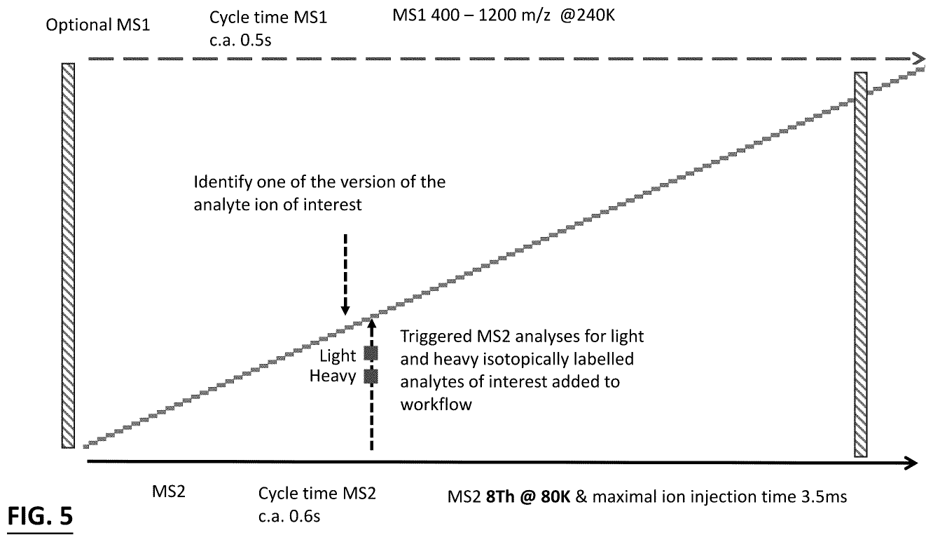

As discussed above, in some embodiments the sample ions may comprise one or more isotopically labelled versions of an analyte ion of interest. In some embodiments, a triggered MS2 analysis may be performed based on the identification of one or more isotopically labelled versions of an analyte ion of interest. FIG. 5 shows a third schematic workflow for a method of mass spectrometry according to this disclosure, in which one version of an isotopically labelled analyte ion of interest is detected.

As shown in FIG. 5, upon detecting a match between a m/z of a spectral peak and a m/z of an isotopically labelled fragment of interest of the target list, one or more triggered MS2 analyses are performed. As noted in FIG. 5, the triggered MS2 analyses may be performed upon detecting any version of the analyte ion of interest. That is to say, identification of an isotopically labelled analyte ion (e.g. provided as part of an internal standard), or the unlabelled version (e.g. an endogenous analyte), may cause the triggered MS2 analysis to be performed. In some embodiments, only the first identification of an analyte of interest (of any version) may cause the one or more triggered MS2 analyses to be performed. As such, where isotopic labelling causes a version of the analyte of interest to be detected in two or more of the plurality of MS2 analyses, only the first identification may cause the triggered MS2 analyses to be performed to avoid performing additional measurements of the same analyte of interest in a single cycle.

Where an isotopically labelled analyte of interest is added to the sample, a user may input information regarding the isotopic labelling to the mass spectrometry system 10 prior to performing the method. Thus, upon identifying at least one of the plurality of isotopically labelled versions of the analyte of interest in the MS2 data, the mass spectrometry system 10 may identify a plurality of isolation windows to mass select the different isotopically labelled versions of the analyte ion of interest. Thus, the method of FIG. 5 further comprises performing one or more triggered MS2 analyses, wherein each triggered MS2 analysis utilises one or more isolation window(s). Each isolation window is utilised to mass select a different isotopically labelled version of the analyte ion of interest.

According to the embodiment of FIG. 5, the sample includes both “light” and “heavy” isotopically labelled versions of an analyte of interest. Thus, in the embodiment of FIG. 5 performing a triggered MS2 analysis comprises mass selecting the sample ions with a first isolation window having the second m/z width. The first isolation window is centred on a m/z of the light isotopically labelled version of the analyte ion of interest to produce first mass selected sample ions. The first mass selected sample ions may be accumulated in the second quadrupole mass filter 70 or accumulated in C-trap 100 following mass selection. The first mass selected sample ions may be accumulated for a second injection time. Preferably, the second injection time is longer than a first injection time used for the plurality of MS2 analyses. For example, in the embodiment of FIG. 5, the first injection time is 3.5 ms, while the second injection time is 5 ms.

The triggered MS2 scan also comprises mass selecting the sample ions with a second isolation window having the second m/z width. The second isolation window is centred on a m/z of the heavy isotopically labelled version of the analyte ion of interest to produce second mass selected sample ions. For each triggered MS2 scan, the second m/z width may be no greater than: 5 Da, 3 Da, or 2 Da. The second mass selected sample ions may be accumulated in the second quadrupole mass filter 70 or accumulated in C-trap 100 following mass selection. As such, the first and second mass selected sample ions may be accumulated together. In some embodiments, a comb-like mass filter may be applied by the quadrupole mass filter to perform the first and second mass selection simultaneously.

The accumulated first and second mass selected sample ions may then be transferred to the fragmentation chamber 120, wherein the accumulated first and second mass selected sample ions are fragmented form triggered fragment ions. The triggered fragment ions may then be transferred to the MRTOF 140. The MRTOF 140 may then mass analyse the triggered fragment ions wherein a mass to charge ratio associated with each spectral peak of the triggered fragment ions is identified.

Thus, as shown in the workflow of 5, sample ions in the m/z range of interest (400to 1200 m/z) are analysed in the MS2 domain with a 100 MS2 analyses. Each MS2 analysis has a first m/z width of 8 Da and a first injection time of 3.5 ms (total MS2 analysis duration 5 ms). The sample ions may also optionally be analysed in parallel in the MS1 domain using the orbital trapping mass analyser 110 (similar to FIGS. 3 and 4). As shown in FIG. 5, two triggered MS2 analyses are performed upon detecting one version of the analyte of interest (either the heavy or light version). A first triggered MS2 analysis is performed for the light isotopically labelled version of the analyte of interest, and a second triggered MS2 analysis is performed for the heavy isotopically labelled version of the analyte of interest. In the embodiment of FIG. 5, the light and heavy isotopically labelled versions are mass selected separately, with the light and heavy isotopically labelled versions each having a second injection time of about 5 ms. The two sets of mass selected sample ions may be co-fragmented and co-analysed in the MS2 domain (i.e. PRM process), such that at least part of the triggered MS2 analyses are multiplexed together. In other embodiments, each triggered MS2 analysis may be performed entirely separately (i.e. a SIM process). Performing the additional triggered MS2 analyses increases the duty cycle by about 10 ms, corresponding to the additional injection times introduced to accumulate the different charge states of the analyte ion of interest.

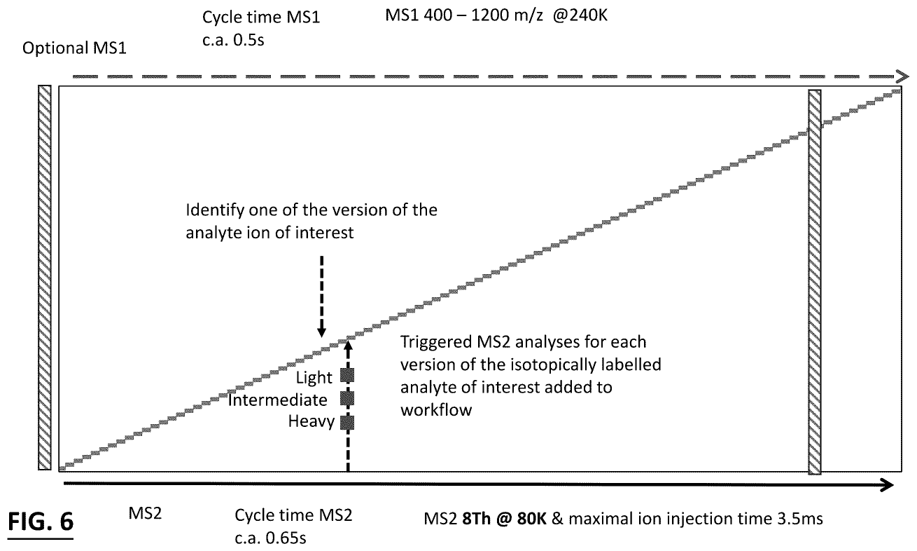

As discussed above, in some embodiments a plurality of different isotopic labels (e.g. at least 2 isotopic labels, or at least 3 isotopic labels) may be prepared for a single analyte of interest. As such, in some embodiments, the sample ions may comprise at least three different isotopically labelled versions of one analyte ions of interest (i.e. three different isotopic labels for a single analyte ion of interest). Each isotopic label may differ in mass by at least 2 Da, preferably at least 4 Da, from adjacent isotopic labels to allow for simplified analysis. FIG. 6 shows a fourth schematic workflow for a method of mass spectrometry according to this disclosure, in which the sample ions comprise at least three isotopically labelled versions of an analyte ion of interest. Similar to the embodiment of FIG. 5, the three triggered MS2 analyses may be performed as SIM analyses, or may be multiplexed and analysed in parallel (i.e. PRM analyses).

While the workflows of FIGS. 3-6 have illustrated one or more triggered MS2 scans being performed upon detecting a version of an analyte of interest in the plurality of MS2 scans, it will be appreciated that methods according to this disclosure are not limited to detecting a single analyte of interest. That is to say, the target list may include m/z information pertaining to a plurality of different analytes of interest. Thus, where a plurality of different analytes of interest are present in the sample simultaneously, the method 100 may include performing a one or more triggered MS2 analyses for each of the analytes of interest which are detected.

Similarly, it will be appreciated that in some embodiments the sample molecules may include isotopic labelling for a plurality of different analytes of interest. As such, the sample ions may comprise a first plurality of isotopically labelled versions of a first analyte of interest and a second plurality of isotopically labelled version of a second analyte of interest. One or more triggered MS2 analysis may be performed upon detecting a version of each of the first and second analytes of interest.

Thus, in accordance with the embodiments of this disclosure a method of mass spectrometry for analysing a sample is provided. It will be appreciated that a controller, which may be processor or computing device, may be configured to control a mass spectrometry system 10 to cause the mass spectrometry system to perform a method according to this disclosure. The controller (e.g. processor or computing device) may perform a method according to this disclosure in accordance with a computer program comprising instructions. The instructions, when executed may cause the mass spectrometry system 10 to execute a method 100 according to this disclosure. Further, the computer program may be stored on a computer-readable medium. The computer-readable medium may be, for example, any suitable computer memory provided as part of the controller, or may be a removable computer-readable medium which may be physically separate from the controller.

1. A method of mass spectrometry for analysing a sample across a mass to charge ratio (m/z) range of interest, comprising:
providing a target list of mass to charge ratios of fragments of interest for the sample to be analysed;
ionising the sample as it elutes from a chromatography system to form sample ions;
performing a plurality of MS2 analyses of the sample ions across the m/z range of interest, wherein performing each MS2 analysis comprises:
mass selecting the sample ions using an isolation window having a first m/z width and fragmenting the sample ions within the isolation window to form fragment ions, wherein for each of the plurality of MS2 analyses, a centre m/z of the isolation window is updated such that the plurality of MS2 analyses cover the m/z range of interest;
mass analysing the fragment ions and determining a mass to charge ratio associated with each spectral peak of the fragment ions; and
comparing the mass to charge ratios of the spectral peaks to the mass to charge ratios of the fragments of interest of the target list,
wherein upon detecting a match between m/z(s) of a set of one or more spectral peak(s) and m/z(s) of a set of one or more fragment(s) of interest of the target list, the method further comprises performing a triggered MS2 analysis of the sample, where the triggered MS2 analysis has a higher sensitivity than a sensitivity of each of the plurality of MS2 analyses.

2. The method of claim 1, wherein the triggered MS2 analysis uses an isolation window having a second m/z width, wherein the second m/z width is narrower than the first m/z width such that the triggered MS2 analysis has a higher sensitivity than each of the plurality of MS2 analyses.

3. The method of claim 1, wherein:
performing each of the plurality of MS2 analyses comprises accumulating sample ions within the isolation window for a first injection time; and
performing the triggered MS2 analysis comprises accumulating sample ions within the isolation window for a second injection time, wherein the second injection time is greater than the first injection time such that the triggered MS2 analysis has a higher sensitivity than each of the plurality of MS2 analyses.

4. The method of claim 3, wherein the second injection time is calculated based on an intensity of the spectral peak(s) matching the fragments of interest on the target list.

5. The method of claim 2, wherein performing a triggered MS2 analysis comprises:
mass selecting the sample ions with an isolation window having the second m/z width;
fragmenting the sample ions within the isolation window to form triggered fragment ions; and
mass analysing the triggered fragment ions wherein a mass to charge ratio associated with each spectral peak of the triggered fragment ions is identified.

6. The method of claim 1, wherein a m/z of a spectral peak is determined to match a m/z of a fragment of interest of the target list when the m/z of the spectral peak is within ±20 ppm.

7. The method of claim 1, wherein detecting a match between m/z(s) of a set of one or more spectral peak(s) and m/z(s) of a set of one or more fragment(s) of interest of the target list comprises identifying that an analyte of interest is present in the sample ions.

8. The method of claim 7, wherein upon identifying that an analyte ion of interest is present in the sample ions, the method further comprises performing a plurality of triggered MS2 analyses, wherein each triggered MS2 analysis has an isolation window which is selected to mass select a different charge state of the analyte of interest.

9. The method of claim 7, wherein upon identifying that an analyte ion of interest is present in the sample ions, the method further comprises performing a triggered MS2 analysis comprising:
mass selecting the sample ions with a first isolation window having a second m/z width, wherein the second m/z width is narrower than the first m/z width such that the triggered MS2 analysis has a higher sensitivity than each of the plurality of MS2 analyses, the first isolation window centred on a m/z of a first charge state of the analyte ion of interest, to produce first mass selected sample ions;
mass selecting the sample ions with a second isolation window having the second m/z width, the second isolation window centred on a m/z of a second charge state of the analyte ion of interest, to produce second mass selected sample ions, wherein the first and second mass selected sample ions are accumulated together;
fragmenting the accumulated first and second mass selected sample ions to form triggered fragment ions; and
mass analysing the triggered fragment ions wherein a mass to charge ratio associated with each spectral peak of the triggered fragment ions is identified.

10. The method of claim 9, wherein the sample ions are mass selected with the first isolation window and the second isolation window simultaneously.

11. The method of claim 1, wherein the sample ions to be analysed comprise a plurality of isotopically labelled versions of an analyte ion of interest and the target list of m/z of fragments of interest comprise m/z of isotopically labelled fragments of interest based on the plurality of isotopically labelled versions of the analyte ion of interest.

12. The method of claim 11, wherein the plurality of isotopically labelled versions of the analyte ion of interest comprises a light isotopically labelled version of the analyte ion of interest and a heavy isotopically labelled version of the analyte ion of interest.

13. The method of claim 11, wherein a triggered MS2 analysis is performed upon detecting a match between m/z(s) of a set of one or more spectral peak(s) and m/z(s) of a set of one or more fragment(s) of interest of the target list associated with one version of the plurality of isotopically labelled versions of the analyte ion of interest.

14. The method of claim 11, wherein performing a triggered MS2 analysis comprises:
mass selecting the sample ions with a first isolation window having a second m/z width, wherein the second m/z width is narrower than the first m/z width such that the triggered MS2 analysis has a higher sensitivity than each of the plurality of MS2 analyses, the first isolation window centred on a m/z of one isotopically labelled version of an analyte ion of interest to produce first mass selected sample ions;
mass selecting the sample ions with a second isolation window having a second m/z width, the second isolation window centred on a m/z of a different isotopically labelled version of the analyte ion of interest, to produce second mass selected sample ions, wherein the first and second mass selected sample ions are accumulated together;
fragmenting the accumulated first and second mass selected sample ions to form triggered fragment ions; and
mass analysing the triggered fragment ions wherein a mass to charge ratio associated with each spectral peak of the triggered fragment ions is identified.

15. The method of claim 1, wherein the plurality of MS2 analyses is performed using a Time of Flight (TOF) mass analyser at a frequency of at least 150 Hz.

16. The method of claim 1, wherein the first m/z width is no greater than 20 Da and the second m/z width is no greater than 5 Da.

17. The method of claim 1, wherein providing the target list of m/z fragments of interest comprises:
receiving data indicative of at least one analyte of interest;
using a computational model to determine a plurality of fragment ions based on the analyte of interest; and
generating the target list of m/z fragments of interest based on the plurality of fragment ions.

18. The method of claim 1, wherein:
the target list of mass to charge ratios of fragments of interest for the sample to be analysed comprises a list of m/z of fragment of endogenous analytes of interest, and
the triggered MS2 analysis of the sample ions is performed based on detecting a match between m/z of the set of one or more spectral peaks and the list of m/z of fragments of endogenous analytes.

19. A controller configured to control a mass spectrometry system analyse a sample received from a chromatography system across a mass to charge (m/z) range of interest, the controller configured to:
obtain a target list of mass to charge ratios of fragments of interest for the sample to be analysed;
cause the mass spectrometry system to ionise the sample as it elutes from the chromatography system to form sample ions;
cause the mass spectrometry system to perform a plurality of MS2 analyses of the sample ions across the m/z range of interest, wherein performing each MS2 analysis comprises:
the controller causing the mass spectrometry system to mass select the sample ions using an isolation window having a first m/z width and to fragment the sample ions within isolation window to form fragment ions, wherein for each of the plurality of MS2 analyses, a centre of the isolation window is updated such that the plurality of MS2 analyses cover the m/z range of interest;
the controller causing the mass spectrometry system to mass analyse the fragment ions and to determine a mass to charge ratio associated with each spectral peak of the fragment ions; and
the controller comparing the mass to charge ratios of the spectral peaks to the mass to charge ratios of the fragments of interest of the target list, wherein upon detecting a match between m/z(s) of a set of one or more spectral peak(s) and m/z(s) of a set of one or more fragment(s) of interest of the target list, the controller is configured to cause the mass spectrometry system to perform a triggered MS2 analysis of the sample ions, where the triggered MS2 analysis has a higher sensitivity than a sensitivity of each of the plurality of MS2 analyses.

20. A mass spectrometry system for analysing sample ions received from a chromatography system across a mass to charge (m/z) range of interest, the mass spectrometry system comprising:
a controller according to claim 19;
an ionisation source configured to receive sample molecules from the chromatography system and to generate sample ions;
a mass selector configured to mass select the sample ions to produce mass selected sample ions;
a fragmentation chamber configured to fragment the mass selected sample ions to produce fragment ions; and
a mass analyser configured to mass analyse the fragment ions.
